(19) United States
(12) Patent Application Publication
(10) Pub. No.: US 2009/0128452 A1
(43) Pub. Date: May 21, 2009

(54) Single Integrated Monitor with Networking and Television Functionality

(76) Inventors: Vlad Bril, Campbell, CA (US); Kris Narayan, Pleasanton, CA (US)

Correspondence Address: DAVIS WRIGHT TREMAINE LLP - San Francisco, 505 MONTGOMERY STREET, SUITE 800, SAN FRANCISCO, CA, 94111, US

(21) Appl. No.: 12/359,047

(22) Filed: Jan. 23, 2009

Related U.S. Application Data
(63) Continuation of application No. 10/229,631, filed on Aug. 27, 2002.
(60) Provisional application No. 60/355,263, filed on Feb. 8, 2002.

(51) Int. Cl. G09G 3/20

(52) U.S. Cl. 345/55

(57) ABSTRACT

A personal computer (PC) monitor system is disclosed in accordance with an embodiment of the present invention to include a display unit and a base coupled the display unit for use by a user. The base includes a control module responsive to input television (TV) signals for processing the same to generate output TV signals, the control module further responsive to input PC data for processing the same to generate output PC data, the control module fixer responsive to input network application data for processing the same to generate output network application data, the control module further responsive to pointer data and low-resolution data, wherein the control module overlays the output network application data, the pointer data, and the low-resolution data to generate a first overlaid output data. The control module transfers the first overlaid output data, the output TV signals, and the output PC data to the display unit for viewing by a user.

### REFERENCE TO PRIOR APPLICATION

This application claims the benefit of previously filed U.S. Provisional Application No. 60/355,263 filed Feb. 8, 2002, and entitled “SINGLE INTEGRATED MONITOR WITH NETWORKING AND TELEVISION FUNCTIONALITY.”

### BACKGROUND OF THE INVENTION

1. Field of the Invention

The present invention relates generally to integrated display systems having a single display unit and particularly to a method and apparatus for enabling a user to access television signals, network application data, and personal computer data from a single display unit.

2. Description of the Prior Art

With the rapid development of modern communication devices the average consumer at home or at workplace may potentially access a variety of sources for information and entertainment. Most of the information is in the form of audio/video signals suitable for displaying on a display unit such as a television display or a personal computer (PC) monitor.

The sources of information include the Internet, electronic mail (e-mail), television cable channels, etc. In particular, network application data such as Web browsing, e-mail, and voice-over-internet protocol (IP) have grown considerably making access to such sources even more desirable.

Traditionally, access to network application data has been established via a PC or a workstation. Recently, network application data may be accessed through the television systems that are equipped to accommodate both televisions signals and network application data.

However, it may be desirable to have an integrated system, such as a display system with enhanced capability, wherein television signals. Network application data, and/or PC data may be displayed on a single display unit screen. In addition, it may be desired for the integrated system to have file capability of overlaying different types of data to present a unified display to the user.

The integrated system should be cost-effective and efficient to replace separate systems, such as a television system and a PC without imposing undue expenses on the consumer. It is fatter desired to have different types of data such as television signals and network application data on different portions of a display unit such that the user may scroll the network application data while viewing the television broadcast without a PC. Yet, the user should be able to use the display unit as a PC whenever desired.

Such an integrated system requires coordination between television signals, network application data, and PC data. It also requires separate processing for each of the aforementioned types of data. For example, the integrated system should have the capability to display different types of data on display units with either analog technologies, such as National Television Systems Committee (NTSC) analog signal displayed on a Cathode Ray Tube (CRT) display unit, or digital technologies such as High Definition Television (HDTV).

In view of the foregoing, the need arises for a method and apparatus for an integrated system for displaying television data, network application data, and PC data in an efficient and cost-effective manner. Further, the integrated system should appear as a standard display monitor with enhanced capability.

### SUMMARY OF THE INVENTION

Briefly, an embodiment of the present invention includes a personal computer (PC) monitor system in accordance with an embodiment of the present invention. The PC monitor system includes a display unit and a base coupled to the display unit. The base includes a control module responsive to input television (TV) signals for processing the same to generate output TV signals, the control module further responsive to input PC data for processing the same to generate output PC data, the control module further responsive to input network application data for processing the same to generate output network application data, the control module further responsive to, pointer data and low resolution data, wherein the control module overlays the output network application data, the pointer data, and the low-resolution data to generate a first overlaid output data. The control module transfers the first overlaid output data, the output TV signals, and the output PC data to the display unit for viewing by a user.

The foregoing and other objects, features and advantages of the present invention will be apparent from the following detailed description of the preferred embodiments which make reference to several figures of the drawing.

### IN THE DRAWINGS

FIG. 1 shows a front view of a personal computer (PC) monitor system including a display unit and a base, according to an embodiment of the present invention.

FIG. 2 shows a back view of a PC monitor system including a display unit and a base, according to an embodiment of the present invention.

FIG. 3 shows various components of a PC monitor system, according to an embodiment of the present invention.

FIG. 4 shows a schematic diagram of a PC monitor system, according to an embodiment of the present invention.

### DETAILED DESCRIPTION OF THE PREFERRED EMBODIMENTS

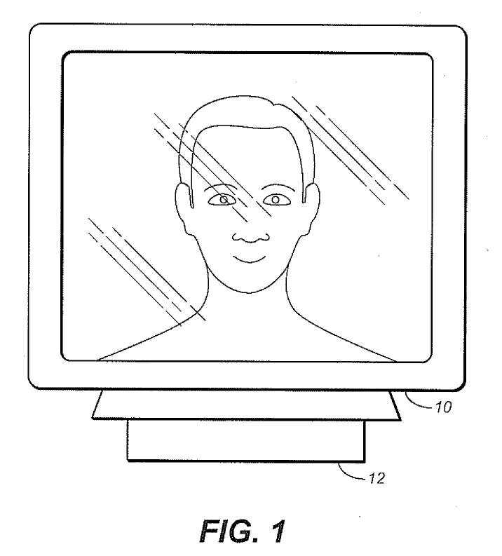

Referring now to FIG. 1, a personal computer (PC) monitor system is shown to include a display unit 10, and a base 12, in accordance with an embodiment of the present invention. The display unit 10 is coupled to the base 12. The PC monitor system shown in FIG. 1 enables the display unit 10 to function as a television (TV) monitor, an Internet browsing/e-mail device, and/or a regular PC terminal. In the embodiment of the present invention shown in FIG. 1, base 12 of the PC monitor system includes a control module that provides multi-purpose capability for the end user. More specifically, the control module enables the user to view normal television (TV) programming, browse the Internet, and use the display unit 10 as a regular PC terminal with the same PC monitor system configuration.

Base 12 shown in FIG. 1, in accordance with an embodiment of the present invention, not only serves as a pedestal to support the display unit 10 but also provides multiple functionality to the end user by including the control module. In addition, if the control module requires any repair, base 12 may be detached from the display unit 10 thereby allowing repairs to be performed without opening the display monitor 10. Accordingly, base 12 becomes a field repair unit (FAU) wherein all repairs may be performed independently of the display unit 10.

Another advantage of the present invention is the economic viability associated with using the control module. A single display unit such as a cathode ray tube (CRT) monitor is used for viewing TV, browsing network applications, and displaying PC data. As a result, the need for a separate TV monitor and computer terminal is eliminated.

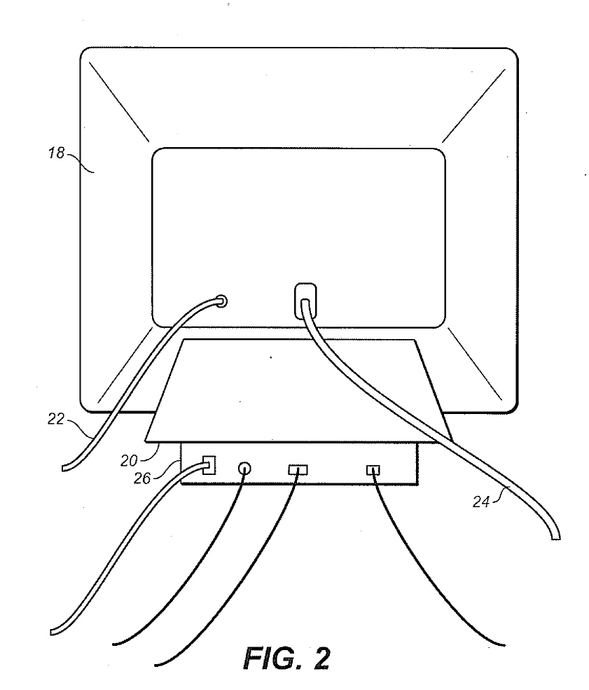

Referring now to FIG. 2, a back view of a PC monitor system is shown to include a display unit 18 and a base 20, in accordance with an embodiment of the present invention. Base 20 is shown to include a control module 26. Connected to the display unit 18 are power cord 22 and cable 24, which connects the latter to the control module 26. Moreover, connected to the control module 26 is a plurality of cables such as a TV cable, a phone/Ethernet connection, and a TV antenna, as described in detail hereinbelow.

In the embodiment shown in FIG. 2, display unit 18 is mounted on the base 20 for structural support. In addition, control module 26 is located inside base 20 whereby signals from TV and other network devices are provided to the display unit 18. Accordingly, base 20 functions as a “smart base” enabling the PC monitor system to display a variety of signals including TV signals, PC data, and various network application data such as electronic mail (e-mail), chat, electronic shopping, and voice-over-Internet Protocol (IP), as described in detail hereinbelow.

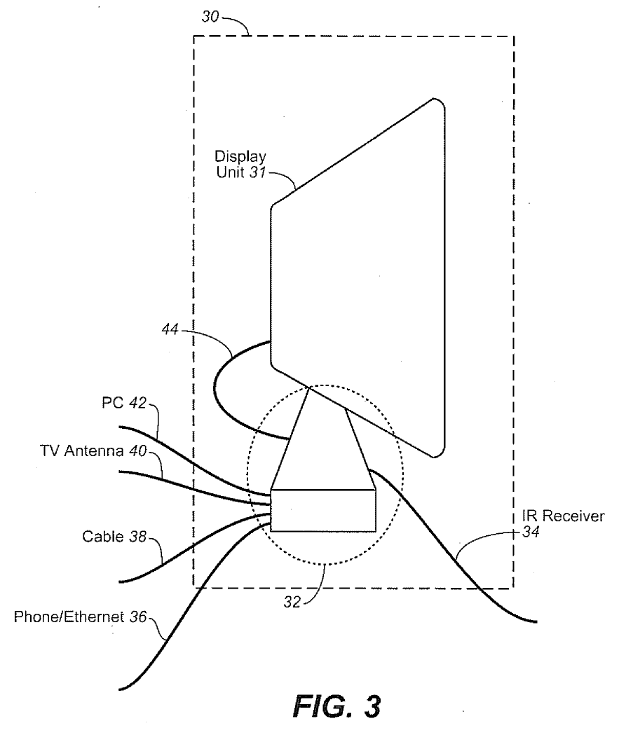

Referring now to FIG. 3, a PC monitor system 30 is shown to include a display unit 31 and a base 32, in accordance with an embodiment of the present invention. The display unit 31 is coupled to base 32 via cable 44. Base 32 receives a plurality of connections that include connection 42 from a PC, connection 40 from a TV antenna, connection 38 from a TV cable box, connection 36 from a phone/Ethernet line, and connection 34 from an infrared (IR) receiver.

The display unit 31 is mounted physically on base 32 for structural support. Base 32 includes a control module that transforms the base 32 into a “smart base” by enabling the PC monitor system 30 to display a variety of data on the screen of the display unit 31. Such data include TV signals, PC data, and network application data such as e-mail, Web browsing, voice-over-IP, etc. The present invention allows different types of data to be displayed on the display unit 31 by overlaying the data as described in detail hereinbelow.

Although the present invention is described in the context of a display unit using analog technology, e.g. a CRT monitor, it will be apparent to those skilled in the art how to implement the present invention with digital technology such as high definition TV (HDTV), flat-panel based TV's, and projection TV's based on digital-mirror-display (DMD) without departing from the scope and spirit of the present invention. In addition, the present invention may be implemented using other technologies such as PLASMA, liquid crystal display (LCD), etc.

The input PC data is provided to base 32 via connection 42 while input TV signals are provided to base 32 either through the T antenna connection 40 or the cable box connection 38. Input network application data is provided to base 32 through the phone line/Ethernet connection 36. In addition, an infrared (IR) receiver (not shown in FIG. 3) is coupled to the base 32 via connection 34. The IR receiver operates in conjunction with remote control devices to perform several functions such as TV control (tuning, voice control, remote control, etc.), network application control, etc. In addition, devices such as keyboards may be interfaced using the IR receiver.

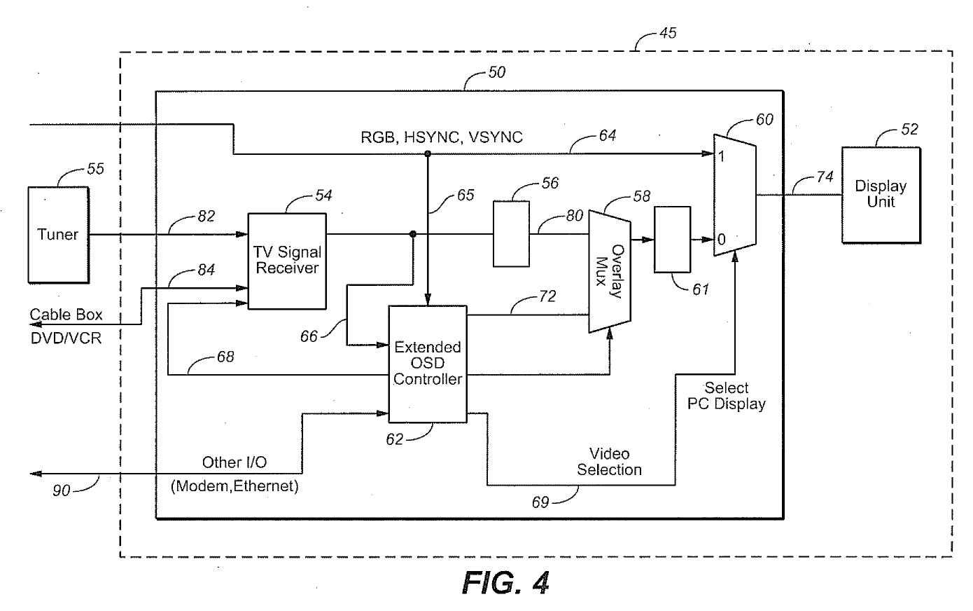

Referring now to FIG. 4, a schematic diagram of a PC monitor system-45 is shown, in accordance with an embodiment of the present invention. The PC monitor system 45 is shown to include a control module 50 and a display unit 52. In one embodiment of the present invention, control module 50 is located in the base of the PC monitor system 45. Control module 50 is coupled to the display unit 52 via connection 74.

Control module 50 includes a TV signal receiver 54, an extended on-screen-display (OSD) controller 62, an overlay multiplexer (mux) 58, a PC data insertion multiplexer 60, a dynamic-range regulating unit 61, and a converter 56. The structure of control module 50 is further disclosed in the U.S. Pat. No. 6,057,888 issued to Vlad Bril on May 2, 2000 and incorporated herein by reference. The extended OSD controller 62 is coupled to the PC data insertion multiplexer 60 through connection 69. The TV signal receiver 54 is coupled to the extended OSD controller 62 and the latter is coupled to the overlay mux 58. The TV signal receiver 54 is also coupled to the converter 56, which is in turn coupled to the overlay mux 58. The overlay mux 53 is coupled to the dynamic-range regulating unit 61 and the latter is coupled to the PC data insertion multiplexer 60. The PC data insertion multiplexer 60 is coupled to the display unit 52 via connection 74.

The PC data insertion multiplexer 60 receives input PC data in the analog red-green-blue (RGB) format as well as horizontal and vertical digital synchronization signals (HSYNC and VSYNC respectively) through connection 64. The TV signal receiver 54 receives input TV signals from sources such as cable service providers, TV stations, digital-video-disk (DVD) players, etc. The extended OSD controller 62 receives input network application data such as e-mails Internet data, voice-over-IP, etc. Control module 50 provides input data from the PC, the TV, and the network to the display unit 52 by overlaying the data thereby enabling the PC monitor system 45 to provide a multiplicity of functions to the end user. In addition, control module 50 provides a pointer to facilitate user interface operation and display of the text used for indicating status messages such as MUTE, VIDEO, etc.

The extended OSD controller 62 and the overlay mux 58 perform overlaying of the input data Output network application data, output TV signals, pointer data, low-resolution data such as text, and other types of data as described hereinbelow are overlaid using a priority system. In one embodiment, the pointer data, i.e. the data on the display unit screen selected by the user either through clicking or some other means, is given the highest priority. That is, when the user places the pointer on the screen of the display unit 52 the data corresponding to the pointer is selected for display on the screen. After the pointer data, the text and the output network application data are given higher priority in that order. The output TV signals are given the lowest priority.

To implement the priority system, control module 50 uses a transparency color. If the type of data corresponding to a particular pixel is set to transparency color, it indicates that the particular data need not be displayed in the pixel position on the screen of the display unit 52. Accordingly, the corresponding data with the next lower priority is considered for display in the same pixel position. If all the different types of data have a value equal to transparency color for a given pixel position, the output TV signals having the lowest priority is displayed in the given position on the display unit screen.

The extended OSD controller 62 models each type of data as a surface mapped independently to a single X-Y coordinate system. Mapping of the different types of data enables the present invention to modify each data type independently. For example, while displaying output TV signals in one portion of the display unit screen, output network application data may be scrolled independently based on user-provided input. The extended OSD controller 62 overlays various data types to provide a unified single display on the screen of the display unit 52.

The TV signal receiver 54 receives input TV signals and decodes the color component of the input TV signals into a format such as the red-green-blue (RGB) format to generate output TV signals. The input TV signals received by the TV signal receiver 54 may further include horizontal and vertical digital synchronization signals (HSYNC and VSYNC respectively). The HSYNC and VSYNC are transferred to the OSD controller 62 via connection 66. Based on the HSYNC and VSYNC, the extended OSD controller 62 generates clock, set-up, and control signals, collectively referred to herein as the OSD data, to coordinate and control the overlaying of images for different types of data. After the pointer data, the OSD data and the output TV signals are given higher priority in that order. The HSYNC and VSYNC operate to insure that the output TV signals and the overlaid image of the output network application data and the text generated by the extended OSD controller 62, correspond to the same pixel on the screen of the display unit 52.

The input to the TV signal receiver 54, received through connection 84, includes signals from a TV cable box, a DVD, or a versatile cassette recorder (VCR). In addition, the TV signal receiver 54 receives input TV signals through connection 82 from a TV tuner 55. In an alternative embodiment of the present invention, control module 50 includes the TV tuner 55 and receives input TV signals from a TV antenna, a cable box, a DVD, or a VCR.

Similarly, the PC data insertion multiplexer 60 receives input PC data usually in analog RGB, HSYNC and VSYNC format. The input PC data is overlaid with the output TV signals, the output network application data, and the OSD data in the PC data insertion multiplexer 60. For simultaneous display of the output TV signals, the OSD data, the input PC data, and the output network application data HSYNC and VSYNC shown in connection 64 drive the extended OSD controller 62 through the connection 65.

Depending on the type of display unit, the PC data insertion multiplexer may be followed by a display interface block (not shown in FIG. 4) that adapts the data and the control setups to the specific display unit's input data and control setups. For example, the input data to an LCD is changed to a digital format and the HSYNC and VSYNC are adapted accordingly.

The extended OSD controller 62 receives input network application data from a modem or an Ethernet line through connection 90. The input network application data is converted in the extended OSD controller 62 into the RGB format to generate output network application data. Although the processing of the input TV signals and the input network application data is described with reference to the ROB format, it is noted that the present invention may be implemented using other formats without departing from the scope and spirit of the present invention. The extended OSD controller 62 overlays the output network application data, the pointer data, and the low-resolution data such as text, according to the aforementioned priority system to generate a first overlaid output data.

Alternatively, the extended OSD controller 62 overlays the output network application data, the pointer data, and the OSD data according to the aforementioned priority system to generate a second overlaid output data. The first and second overlaid output data are transferred to the overlay mux 58 via connection 72.

The overlay mux 58 receives the output TV signals via connection 80 and the first and second overlaid output data via connection 72. The overlay mux 58 performs further overlaying by selectively forwarding one of the two inputs to the PC data insertion multiplexer 60. The selection between the output TV signals and the first and second overlaid output data is based on a blank signal generated by the extended OSD) controller 62 and sent to the overlay mux 58 via connection 70. One value of the blank signal causes the overlay mux 58 to select the output TV signals and the other value of the blank signal causes the overlay mux 58 to select the first and second overlaid output data. In addition, the extended OSD controller 62 generates a PC display signal that is sent to the PC data insertion multiplexer 60 via connection 69. The output of the overlay mux 58 is received by the dynamic-range regulating unit 61 which generates ROB analog output in the dynamic range required by a cathode-ray-tube (CRT) display unit.

In addition, the extended OSD controller 62 generates a half-tone signal, which is sent through connection 68 to the TV signal receiver 54. The halftone signal provides a mechanism by which the input TV signals are altered in intensity in specific pixel positions. For example, the low-resolution data may include the text “MUTE”. If the input TV signals in the pixel position designated for the text are not altered, the text “MUTE” may not be clearly visible. Instead, the half-tone signal causes the input TV signals to be altered, i.e. darkened in intensity, in the pixel position corresponding to the text. As a result, the text “MUTE” would be more clearly visible to the user.

The input TV signals received by the TV signal receiver 54 are sent to the converter 56. The converter 56 is an optional unit for converting non-interlaced TV images to interlaced images whereby odd lines and even lines of the image are provided alternately. However, converter 56 may be eliminated if non-interlaced technology is implemented the display unit 52 to display images on the screen.

If the display unit 52 is an LCD or some other display unit receiving digital signals directly, the analog RGB format on connection 74 will be first converted to digital signals and possibly upscaled to fill the resolution of the display unit. Under such circumstances, specific power on/off sequencing may be provided.

Alternatively, it is possible that the PC and the extended OSD controller 62 output digital signals directly, fitted to be displayed on a digital interface display unit. Standards for digital interface display units are known to those skilled in the art.

In addition, the dynamic-range regulating unit 61 controls the voltage range of the output in order to maintain the same image quality as in a regular TV monitor when the output comprises output PC data, output TV signals, and the first and second overlaid output data. Depending on the user demand, the PC data insertion multiplexer 60 transfers either the output PC data or the output TV signals with the first and second overlaid output data or a combination thereof via connection 74 to the display unit 52 for viewing by the user.

Although the present invention has been described in terms of specific embodiment, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1-21. (canceled)

22. An integrated display system for use by a user comprising:
a display unit; and
a pedestal base detachably coupled to structurally support said display unit, the pedestal base including therein a control module, said control module responsive to: input television (TV) signals for processing the same to generate output TV signals; input computer data for processing the same to generate output computer data; input network application data for processing the same to generate output network application data; pointer data; and low-resolution data,
wherein said control module overlays said output network application data, said pointer data, and said low-resolution data to generate a first overlaid output data and transfers said first overlaid output data, said output TV signals, and said output computer data to said display unit for viewing by a user, and
wherein said control module includes:
an extended on-screen-display controller for generating said first overlaid output data, said extended on-screen-display controller further overlaying said input TV signals with said low-resolution data, and
a TV signal receiver, where said extended on-screen-display controller transfers half-tone signals to said TV signal receiver for overlaying said low-resolution data and said input TV signals.

23. The integrated display system of claim 22, wherein said base is a field repair unit wherein repairs on said base are performable independently of said display unit.

24. The integrated display system of claim 22, wherein said input network application data include electronic mail (email), Web-browsing, and voice-over-internet protocol.

25. The integrated display system of claim 22, wherein said base is coupled to an inferred (IR) receiver for operating with a remote control device to control said output TV signals and said output network application data.

26. The integrated display system of claim 22, wherein technologies implemented within said display unit include digital mirror display (DMD), PLASMA, liquid crystal display (LCD), and analog technology.

27. The integrated display system of claim 22, wherein said control module further includes:
an overlay multiplexer for overlaying said first overlaid output data and said output TV signals.

28. The integrated display system of claim 22, wherein said control module further includes:
a computer data insertion multiplexer responsive to said input computer data for processing the same to generate said output computer data, said computer data insertion multiplexer further transferring said output computer data, said first overlaid output data, and said output TV signals to said display unit for viewing by a user.

29. The integrated display system of claim 28, wherein said display unit includes a screen, said computer data insertion multiplexer controls the voltage range of said output computer data for displaying high quality images on said screen of said display unit.

30. The integrated display system of claim 29, wherein said computer data insertion multiplexer being prompted by a user to transfer said output computer data, said output TV signals, and said first output overlaid data to said display unit.

31. The integrated display system of claim 29, wherein said output TV signals are displayed on a first portion of said screen of said display unit and said output network application data is displayed on a second portion of said screen of said display unit, said network application data being scrolled by a user.

32. The integrated display system of claim 28, wherein said control module includes a TV signal receiver responsive to said input TV signals for processing the same to generate said output TV signals, said TV signal receiver receiving said input TV signals from a TV tuner, a cable TV provider, a digital video disk (DVD) player, and a versatile cassette recorder (VCR).

33. The integrated display system of claim 32, wherein said TV signal receiver receives said TV input signals from a TV tuner, said TV tuner being located externally to said integrated display system.

34. The integrated display system of claim 32, further including a TV tuner for generating said input TV signals, said TV signal receiver being responsive to said input TV signals.

35. The integrated display system of claim 22, wherein said control module includes a converter for converting said output TV signals from a non-interlaced format to an interlaced format.

36. A pedestal base detachably connectable to structurally support a display unit of a computer monitor system, the pedestal base including therein:
a control module, said control module responsive to: input television signals for processing the same to generate output television signals; input computer data for processing the same to generate output computer data; input network application data for processing the same to generate output network application data; pointer data; and low-resolution data, wherein said control module overlays said output network application data, said pointer data, and said low-resolution data to generate a first overlaid output data and transfers said first overlaid output data, said output television signals, and said output computer data to said display unit for viewing by a user, and wherein said control module includes:
an extended on-screen-display controller for generating said first overlaid output data, said extended on-screen-display controller further overlaying said input television signals with said low resolution data, and
a television signal receiver, where said extended on-screen-display controller transfers half-tone signals to said television signal receiver for overlaying said low-resolution data and said input television signals.
